(19) United States
(12) Patent Application Publication
(10) Pub. No.: US 2015/0317647 A1
(43) Pub. Date: Nov. 5, 2015

(54) Method And Apparatus For Correlating Biometric Responses To Analyze Audience Reactions

(71) Applicant: THOMSON LICENSING, Issy Les Moulineaux (FR)

(72) Inventors: Jorge Fernando JORGE, San Francisco, CA (US); Brian ERIKSSEN, San Jose, CA (US); Anmol SHETH, San Francisco, CA (US)

(73) Assignee: Thomson Licensing

(21) Appl. No.: 14/653,520

(22) PCT Filed: Aug. 13, 2013
(86) PCT No.: PCT/US2013/054619

§ 371 Date: Jun. 18, 2015

Related U.S. Application Data
(60) Provisional application No. 61/749,051, filed on Jan. 4, 2013.

(51) Int. Cl. G06Q 30/02; H04N 21/442

(52) U.S. Cl. CPC G06Q 30/0201; H04N 21/44218

(57) ABSTRACT

A method for analyzing audience reaction while viewing audio-visual content commences by first collecting biometeric data from audience members while viewing the audio-visual content. The collected biometric data undergoes cross-correlation to establish a correlation graph having nodes indicative of individual audience member's reaction to the viewed audio-visual content. Thereafter, edges in the graph corresponding to nodes, which are similar, are identified to indicate audience members reacting similarly to the viewed content.

### CROSS-REFERENCE TO RELATED APPLICATIONS

This application claims priority under 35 U.S.C. 119(e) to U.S. Provisional Patent Application Ser. No 61/749,051, filed Jan. 4, 2013, teachings of which are incorporated herein.

### TECHNICAL FIELD

This invention relates to a technique for analyzing the reaction of audience members to viewed content.

### BACKGROUND ART

Movie and TV studios typically perform audience testing as part of their market research activities in connection with existing and proposed content offerings. The ultimate goals of individual test screenings may vary (e.g., marketing, editing) but, at a high level, studios desire feedback that helps them predict how audiences will react to the content offering. Current best practices for audience testing generally rely on explicit feedback obtained through comment cards and focus group interviews. Although these techniques enjoy widespread use by the market research industry, these techniques incur criticism for being unreliable and too coarse-grained. The unreliability of such techniques stems from the fact that different people may subjectively interpret the question being asked in a comment card and may respond differently depending on the audience member's memory or the social context of a focus group.

Collecting audience member's biometric data, such as electro dermal activity (EDA), can enable fine-grained and objective assessments of the audience member's emotional reactions. However, personal reactions can prove hard to interpret because an individual's anatomy as well as noise introduced by sensor placement can influence that person's responses. Aggregating audience-wide measurements will reduce the influence of these individual characteristics in favor of an overall response. Aggregation, however, requires something more than just averaging the biometric data of multiple audience members, as their individual responses can possess different statistics depending on skin and sensor properties.

There exists research on how to convert biometric sensor readings (e. g, EDA, EEG, heart rates) into emotions. Such research addresses a much harder problem than that associated with audience testing. Moreover, research in this area has revealed the difficulty in building models for general-purpose applications, as the ground truth labels (e.g., the actual emotions) needed to learn the values for such parameters have proven hard to obtain. There also exist efforts to cross-correlate functional Magnetic Resonance Imaging (fMRI) data of audience members watching a short segment of a movie to collect brain activity. Such research has demonstrated that a large cross correlation exists across audience participants, indicating that they experience a viewed movie similarly to each other. Since this research relies on functional MRI data, some doubt exists whether and to what extent this methodology can apply to actual audience testing. To successfully carry out a functional MRI scan, the audience member must lie down in a confined space and remain completely still for the duration of the measurement. Any audience member movement can compromise the data. In addition, MRI machines cost large sums of money and incur significant operating costs, thus limiting data collection to one audience member at a time.

In the past, market researchers have computed the correlation between audience members and content metadata to determine certain elements of the movie (e.g., characters, locations, sounds, etc.) which help explain the reactions observed from analyzing user feedback data. Such efforts have focused on interpreting the reactions of an individual watching content, typically for personalization tools such as recommendation engines, but such efforts do not yield any information on the audience as a whole.

Thus, a need exists for a technique for analyzing audience reaction which overcomes the aforementioned disadvantages of the prior art.

### BRIEF SUMMARY OF THE INVENTION

Briefly, in accordance with a preferred embodiment of the present principles, a method for analyzing audience reaction while viewing audio-visual content commences by first collecting biometric data from audience members while viewing the audio-visual content. The collected biometric data undergoes cross-correlation to establish a correlation graph having nodes indicative of individual audience member's reaction to the viewed audio-visual content. Thereafter, edges in the graph corresponding to nodes, which are similar, are identified to indicate audience members reacting similarly to the viewed content.

### BRIEF DESCRIPTION OF THE DRAWINGS

FIG. 1 depicts a block schematic diagram of an analysis engine in accordance with a preferred embodiment of the present principles for correlating biometric data collected from audience members simultaneously viewing audio visual content to determine the reaction of individual audience members to that content;

FIG. 2 depicts a re-sampling mechanism within the analysis engine of FIG. 1 for re-sampling biometric data collected from audience members in parallel with the correlation of that data; and

FIG. 3 depicts a graph of the collective reaction of audience members to different movies as a function of time, as determined by the analysis engine of FIG. 1.

### DETAILED DESCRIPTION

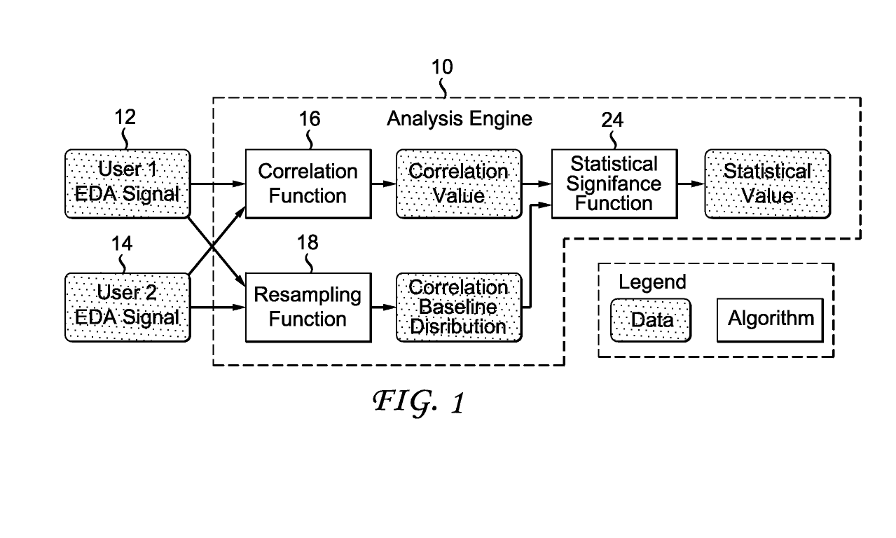

In accordance with the present principles, an analysis engine 10 depicted in FIG. 1 can determine the reaction of audience members to viewed audio-visual content (e.g., movies and television program) from biometric data collected from the audience members. In practice, the biometric data takes the form of multiple streams of Electro Dermal Activity (EDA) (not shown), with each stream originating from an individual audience member watching the content. Capture of the individual streams can occur in parallel for real-time analysis, if the whole audience watches the content simultaneously, or in multiple sessions, for offline analysis. The streams typically undergo synchronization by an external method, e.g., through a mark on an EDA signal trace for reference to a corresponding point in the content, such as the beginning of the movie.

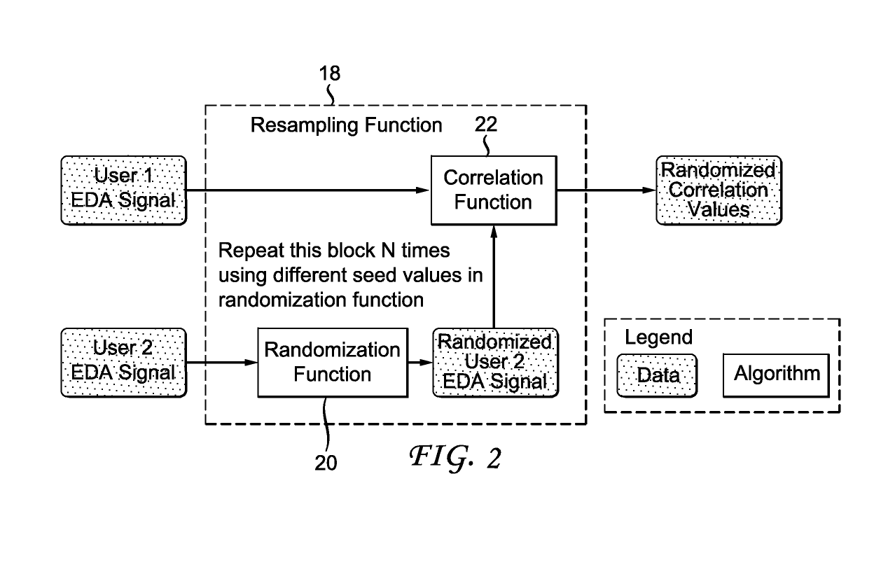

For purposes of simplification, FIG. 1 depicts the receipt by the analysis engine 10 of EDA data streams from a pair of audience members 12 and 14, whereas in practice, the analysis engine would typically receive EDA data streams from many more audience members. The analysis engine 10 receives the EDA data streams from the audience members 12 and 14 at a correlation function 16 and at a resampling function 18, the latter described in greater detail with respect to FIG. 2. The correlation function 16 comprises a data processor (for example a personal computer) programmed to perform correlation on the received audience member EDA data streams in the manner described hereinafter. The correlation function 16 of the analysis engine 10 of FIG. 1 aggregates the EDA data streams from the audience members 12 and 14 into overlapping fixed-length time windows (e.g., 5 minutes long with 1-second steps). At every point in time, the correlation function 16 will process the current set of 5-minute windows for all audience members using an algorithm that builds a correlation graph where the nodes represent audience members' individual reactions to the viewed content and two nodes become connected by an edge if the two corresponding audience members react similarly to the content during that 5-minute window.

In order to build the correlation graph, the correlation function 16 of FIG. 1 computes the pairwise correlations across all pairs of audience members for a given a snapshot of the EDA signals for the audience members for each fixed-length time window. In particular, the correlation function 16 performs a non-parametric hypothesis test to determine whether or not the reactions of the two audience members appear similar during the time represented by the snapshot. First, the correlation function 16 correlates the EDA streams for the particular pair of audience member and then generates a score reflecting how much the two signals appear statistically similar to each other.

The correlation function 16 can make use of different correlation techniques, including, but not limited to, the dot product (also known as cosine similarity) of the two signals or the mutual information between the signals. Different correlation techniques will have different characteristics with respect to the incidence of false positives and their impact may depend on the type of analysis being performed with the final correlation graphs.

In parallel with the correlation carried out by the correlation function 16, a resampling function 18 within analysis engine 10 of FIG. 1 establishes a baseline distribution for the correlation values in accordance with the input EDA streams from the audience members (e.g., audience members 12 and 14 of FIG. 1). Referring to FIG. 2, the resampling function 18 typically comprises a data processor (not shown), either the same as or separate from the data processor comprising the correlation function 16 of FIG. 1. The resampling function 18 of FIG. 2 includes a randomizing function 20 that generates a randomized version of one of the pair of received audience member EDA streams to preserves some of that stream's statistical properties but breaks any potential correlation that the stream had with the other input stream received by the resampling function 18 of FIG. 2. The randomizing function 20 can make use of different randomization techniques depending on which statistics one wishes to preserve from the signal. For example, a simple cyclic shift remains sufficient to break correlation but will still preserve most other statistical properties, such as the mean, variance and autocorrelation of the transformed signal. This transformed signal is the same as the “randomized version of the stream. On the other hand, a randomizing technique that shuffles all the points in the signal will preserve the mean and variance, but not the autocorrelation. The choice of the randomization technique can impact the sensitivity of the algorithm, i.e., how often it detects cross correlation when the two signals appear truly correlated.

The randomization function 20 will apply randomization to one of the input signals several times, each time with a different random seed to generate a different randomized output signal. For each different randomized output signal, a correlation function 22 in the resampling function 18 of FIG. 2 will compute the correlation with the other input signal and store these values to form a baseline distribution of correlation values. In this regard, the correlation function 22 will use the same correlation technique as the correlation function 16 of FIG. 1.

Referring to FIG. 1, the analysis engine 10 includes a statistical significance function 24 for comparing the correlation value between the pair of audience member EDA signals generated by the correlation function 16 to the baseline distribution generated by the resampling function 18 to determine the statistical significance (if any) therebetween. In practice, the statistical significance function 24 comprises a data processor, the same as or different from the data processor(s) comprising the correlation function 16 and/or the resampling function 18, both of FIG. 1. Essentially, the statistical sampling function 24 estimates the probability the generated baseline distribution values having a larger value than the observed correlation value. If this probability has a value less than a small threshold (e.g., 0.1%), then the statistical sampling function 24 will deem the EDA signals for the pair of audience members (e.g., audience members 12 and 14 of FIG. 1) similar to each other for the duration of the snapshot.

After computing the significance of pairwise correlations for all pairs of individual audience members, the statistical significance function 24 can build a correlation graph by mapping the correlations of the statistically significant correlated audience member EDA data streams. Such a correlation graph will have nodes for each audience member. Further, the statistical significance function 24 will add an edge to the correlation graph between a pair of nodes if and only if nodes exhibit similarity during the snapshot, i.e., if their pairwise correlation exhibits statistical significance as described above. Note that the correlation graph only represents the data contained in a snapshot (e.g., a 5-minute window). The analysis engine 10 of FIG. 1 will repeat this procedure for all snapshots for the duration of the content, generating potentially different correlation graphs for the snapshots.

The set of graphs obtained for all snapshots collectively represent a single dynamic graph where the set of nodes (i.e., audience members) never changes, but the edges between them get added or removed over time, as the audience member's reactions become more or less similar to each other. Such a dynamic graph provides a rich description of how audience members engage with the content. Analysis of the graph structure can occur using different metrics, including the edge density across time, the sizes of cliques in the graph and the spectral properties of the graph (i.e., Eigen-values of the graph's Laplacian).

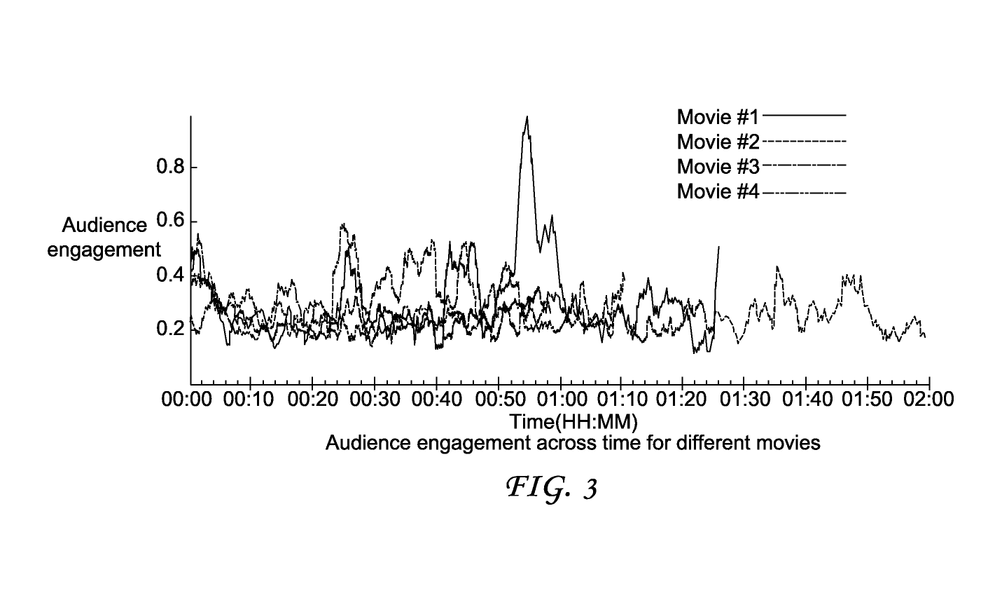

FIG. 3 depicts a set of correlation graphs for four separate movies. For each movie, the analysis engine 10 of FIG. 1 collected and analyzed EDA data for an audience of 20 members watching the movie simultaneously. Applying the aforementioned methodology, the analysis engine 10 computed dynamic graphs for each movie and measured the edge density over time for these graphs. This metric represents the fraction of edges in the graph of FIG. 3 active at a given point in time. Intuitively, the more pairs of audience members connected through edges, the more effective the movie in making the audience share the same experience.

The foregoing described a technique for analyzing the reaction of audience members to viewed content.

1. A method for analyzing audience reaction while viewing audio-visual content, comprising the steps of:
collecting biometric data from audience members while viewing the audio-visual content;
cross-correlating the collected biometric data to establish a correlation graph having nodes indicative of individual audience member's reaction to the viewed audio-visual content; and
identifying edges in the graph corresponding to nodes, which are similar to indicate audience members reacting similarly to the viewed content.

2. The method according to claim 1 wherein the biometric data comprise a stream of Electro Dermal Activity (EDA) streams of each of the audience members.

3. The method according to claim 2 wherein the EDA streams are synchronized to the viewed content.

4. The method according to claim 1 wherein the cross-correlating step comprises computing correlations between pair-wise audience members' biometric data.

5. The method according to claim 4 wherein the cross-correlating step comprises:
correlating pair-wise audience members' biometric data to generate a correlation value;
randomizing at least one of the pair-wise audience members' biometric data;
correlating the randomized one of the pair-wise audience members' biometric data and non-randomized one of the pair-wise audience members' biometric data to generate a correlated baseline distribution value; and
comparing the correlation value to the correlated baseline distribution value to establish cross-correlation between the pair-wise audience members' biometric data.

6. A apparatus for analyzing audience reaction while viewing audio-visual content, comprising:
an analysis engine for (a) cross-correlating biometric data collected from audience members to establish a correlation graph having nodes indicative of individual audience member's reaction to the viewed audio-visual content; and (b) identifying edges in the graph corresponding to nodes, which are similar to indicate audience members reacting similarly to the viewed content.

7. The apparatus according to claim 6 wherein the biometric data comprises multiple Electro Dermal Activity (EDA) streams, each associated with an individual audience members.

8. The apparatus according to claim 6 wherein the analysis engine correlates the collected biometric data by computing correlations between pair-wise audience members' biometric data.

9. The apparatus according to claim 8 further comprising:
means for correlating pair-wise audience members' biometric data to generate a correlation value;
means for randomizing at least one of the pair-wise audience members' biometric data;
means for correlating the randomized one of the pair-wise audience members' biometric data and non-randomized one of the pair-wise audience members' biometric data to generate a correlated baseline distribution value; and
means for comparing the correlation value to the correlated baseline distribution value to establish cross-correlation between the pair-wise audience members' biometric data.
